(19) United States
(12) Patent Application Publication
(10) Pub. No.: US 2025/0083705 A1
(43) Pub. Date: Mar. 13, 2025

(54) METHOD FOR IMPROVING THE SAFETY OF A DRIVING ASSISTANCE SYSTEM OF A VEHICLE

(71) Applicant: Robert Bosch GmbH, Stuttgart (DE)

(72) Inventors: Annika Brettschneider, Leonberg (DE); Thomas Brettschneider, Leonberg (DE)

(21) Appl. No.: 18/769,696

(22) Filed: Jul. 11, 2024

(30) Foreign Application Priority Data
Sep. 11, 2023 (DE) 10 2023 208 745.6

(51) Int. Cl. B60W 60/00; B60W 50/14

(52) U.S. Cl. CPC B60W 60/0016; B60W 50/14; B60W 2555/00

(57) ABSTRACT

A method for improving the safety of a driving assistance system of a vehicle. The method includes: detecting a hazardous situation of the vehicle based on at least one situation-dependent driving parameter; providing a defined base action path including at least a first action portion, wherein, within the first action portion, at least a first vehicle-side action that is suitable to bring the vehicle into a safe state is triggered depending on the detected hazardous situation; assessing the detected hazardous situation for the vehicle; adjusting the base action path depending on the assessment of the detected hazardous situation for the vehicle.

### CROSS REFERENCE

The present application claims the benefit under 35 U.S.C. § 119 of German Patent Application No. DE 10 2023 208 745.6 filed on Sep. 11, 2023, which is expressly incorporated herein by reference in its entirety.

### FIELD

The present invention relates to a method for improving the safety of a driving assistance system of a vehicle.

### BACKGROUND INFORMATION

Automated driving functions, up to SAE level 3, require concepts for handover to the driver in the event of a fault or for warning the driver if the driver is not performing their still existing obligation to monitor the automated driving function. The higher the level of automation, the more the driver is relieved and the higher the risk that a driver cannot immediately take control of the vehicle again at all times. This may be because the hands of the driver are not resting on the steering wheel.

Alternatively, a driver may be overfatigued or so inattentive that it takes several seconds for the driver to take over the vehicle guidance again.

It is therefore important that a driving assistance system monitors its own proper functioning, hazards to the vehicle in the near future, and the fitness to drive and attention of the driver and, if necessary, asks the driver in good time to take over the control of the vehicle.

Methods for handover to the driver are described in the related art. In simple driving assistance systems, such as ACC, the assistance function is switched off immediately in the event of a fault and the driver is informed in the HMI.

For lane keeping systems, the driver receives a visual and/or acoustic warning if the driver takes their hands off the steering wheel. If the driver does not take over the steering wheel for a certain amount of time, the assistance function is deactivated.

For assistance functions for which the driver no longer has their hands on the steering wheel, the attention of the driver is monitored (e.g., GM Super Cruise). If attention is no longer given, an escalation path of measures, which can be stopped by the driver at any point through the required interaction, is triggered. In this case, the driver is initially warned visually. If this does not get the attention of the driver, the driver is additionally warned by acoustic and haptic signals. If this is also not successful, an acoustically spoken announcement appears, which asks the driver to take over the steering wheel immediately. If this also fails, the vehicle is braked to a stop in a controlled manner by the assistance function and the vehicle is secured.

It is disadvantageous in the related art that the execution of such an escalation path has been fixed in the development phase. A general example of an escalation path is described in German Patent Application No. DE 10 2016 225 181 A1. Precious time, which may not exist depending on the situation, can thus pass. This problem is exacerbated especially if the associated vehicle architecture lacks redundancy of steering and/or brake, for example, so that, in the event of a fault, there is no time to switch to a fallback steering system or braking system. If the escalation path is fully executed for all types of faults, precious time is wasted and a safety risk may develop.

It is therefore an object of the present invention to provide a solution by means of which the safety of an (automated) driving function can be increased in an efficient and reliable manner.

### SUMMARY

This object may be achieved by a method for improving the safety of a driving assistance system of a vehicle with features of the present invention.

According to a first aspect, the present invention relates to a method for improving the safety of a driving assistance system of a vehicle. The driving function may be automated.

According to an example embodiment of the present invention, in a first step, a hazardous situation of the vehicle is detected on the basis of at least one situation-dependent driving parameter.

In a second step, a defined base action path comprising at least a first action portion is provided, wherein, within the first action portion, at least a first vehicle-side action that is suitable to bring the vehicle into a safe state is triggered depending on the detected hazardous situation.

In a third step, the detected hazardous situation for the vehicle is assessed.

In a fourth step, the base action path is adjusted depending on the assessment of the detected hazardous situation for the vehicle.

A basic feature of the present invention is that, in the case of imminent danger or a safety-critical situation, modifications to the base action path are made during the run time depending on the recognized situation with the need for action, starting from a basic definition of an escalation path or base action path. For example, the first steps of the base action path at the beginning may be skipped. Alternatively, individual steps of the base action path may be skipped during execution. Further alternatively, the duration and/or parameters of the base action path that are relevant to the individual steps may be adjusted.

In this way, depending on the present or detected situation for the vehicle, the base action path is correspondingly flexibly adjusted and does not have to be fully executed if the detected safety-critical situation does not permit it or if there is no time for it, in order to bring the vehicle into a safe state.

The following advantages can be achieved with the method according to the present invention:

An advantage is that the overall duration of the escalation path or base action path can be variably adjusted in the vehicle during the run time. If an escalation path is always started at the lowest escalation level and if an escalation path is always fully executed, the driver may receive the impression that they still have enough time and do not have to react immediately. However, this time may not be available depending on the situation, so that the driver does not understand the seriousness of the situation. The method presented here allows the escalation path to be adjusted. This can increase the safety of a driving function. Alternatively, a driving function may, for example, be operated at higher speeds at a comparable safety to today's systems.

A further advantage of the method according to the present invention is that, at the same time, it is however not necessary to define a separate escalation path or base action path or action path for each possible hazardous situation. Even for complex functions, a single basic definition of an action path may be sufficient. This simplifies the development of modern driving assistance functions in particular. In addition, the driver generally experiences a similar sequence of the escalation path across various driving functions. This increases confidence in a driving assistance function and thus customer acceptance.

One possible embodiment of the method of the present invention provides that the at least first vehicle-side action consists of at least one of the following actions for warning at least one person located in the vehicle: visual warning, haptic warning, acoustic warning, olfactory warning, an automated intervention in a vehicle behavior of the vehicle. This achieves the advantage that, depending on a detected safety-critical or safety-relevant situation for the vehicle, the corresponding and respectively suitable vehicle-side action is triggered in order to bring the vehicle into a safe state.

One possible embodiment of the method of the present invention is that the adjustment of the base action path provides for adjusting a degree of execution of the at least first vehicle-side action. This achieves the advantage that, depending on a detected safety-critical or safety-relevant situation or a severity of an identified safety risk for the vehicle, the corresponding and respectively suitable vehicle-side action is triggered in order to bring the vehicle into a safe state.

One possible embodiment of the method of the present invention provides that the adjustment of the base action path takes place if a detected time period for the detected hazardous situation to occur is less than a time period for executing the entire base action path. This ensures that the vehicle can be brought into a safe state in good time.

One possible embodiment of the method of the present invention provides that the base action path comprises at least a second action portion, which follows the first action portion, wherein, within the at least second action portion, at least a second vehicle-side action is triggered depending on the detected hazardous situation. This achieves the advantage that the base action path has a clear and structured sequence of action portions.

One possible embodiment of the method of the present invention is that an adjustment of the base action path provides that the first and second action portions and/or the vehicle-side actions overlap in time. This achieves the advantage that, depending on a detected safety-critical or safety-relevant situation for the vehicle, the corresponding and respectively suitable vehicle-side action is triggered in order to bring the vehicle into a safe state.

One possible embodiment of the method of the present invention provides that the vehicle-side actions extend across the respective first and second action portions. This achieves a flexible and driving-situation-dependent adjustment of the base action path.

One possible embodiment of the method of the present invention provides that the respective first and second action portions differ with respect to a response of the driver assistance system when a driver in the vehicle reacts to the at least one vehicle-side action. This achieves a flexible and driving-situation-dependent adjustment of the base action path.

One possible embodiment of the method of the present invention provides that, when adjusting the base action path, individual action portions are specifically excluded from being carried out if this is required to achieve a defined safety state of the vehicle. This achieves a flexible and driving-situation-dependent adjustment of the base action path in order to always bring the vehicle into a safe state. In or during the execution of the adjusted action path, the safety of the vehicle occupant is also taken into account when certain driving maneuvers are excluded for carrying out the adjusted action path in order to bring the vehicle into the safe state.

One possible embodiment of the method of the present invention provides that the adjustment of the base action path provides for skipping individual vehicle-side actions. This achieves a flexible and driving-situation-dependent adjustment of the base action path in order to bring the vehicle into an adequately secured state.

One possible embodiment of the method of the present invention provides that the at least one situation-dependent driving parameter represents at least one of the following hazardous situations for the vehicle that require an adjustment of the base action path: malfunction of the driving assistance system of the vehicle, recognizing a traffic situation for the vehicle that can no longer be safely managed by the driving assistance system of the vehicle. This achieves the advantage that, depending on a detected safety-critical or safety-relevant situation for the vehicle, the corresponding and respectively suitable vehicle-side action is triggered in order to bring the vehicle into a safe state.

One possible embodiment of the method of the present invention provides that the vehicle is an at least partially autonomously driving vehicle. This achieves the advantage that, when carrying out the method, the safety of the vehicle occupant is increased by increasing the safety of a, possibly automated, driving function.

According to a second aspect, the present invention relates to a computer program containing machine-readable instructions which, when executed on one or more computers and/or compute instances, cause the computer(s) or compute instance(s) to perform the method according to the present invention.

According to a third aspect, the present invention relates to a machine-readable data carrier and/or download product with the computer program of the present invention.

According to a fourth aspect, the present invention relates to one or more computers and/or compute instances with the computer program and/or with the machine-readable data carrier and/or the download product.

Further measures improving the present invention are described in more detail below with reference to the figures, together with the description of the preferred embodiment examples of the present invention.

### BRIEF DESCRIPTION OF THE DRAWINGS

FIG. 1 shows a schematic flowchart of the method 100 for improving the safety of a driving assistance system 60 of a vehicle 70 according to an example embodiment of the present invention.

FIG. 2 shows a schematic definition of a base action path according to an example embodiment of the present invention.

### DETAILED DESCRIPTION OF EXAMPLE EMBODIMENTS

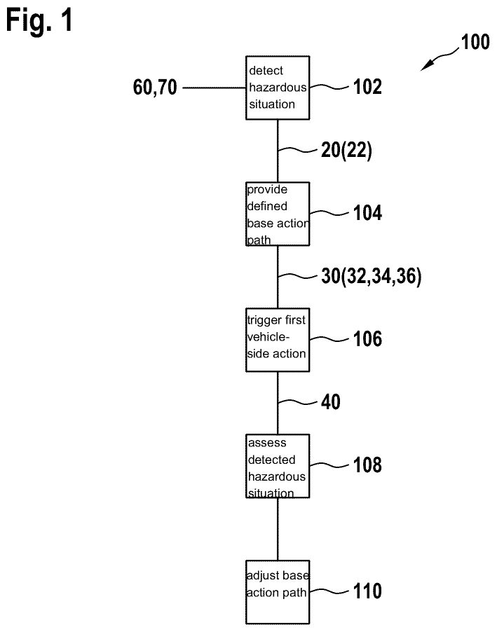

FIG. 1 shows a schematic flowchart of the method 100 for improving the safety of a driving assistance system 60 of a vehicle 70 according to an example embodiment of the present invention.

The vehicle 70 may preferably be designed as an at least partially autonomously driving vehicle, which provides automated driving functions.

In a step 102, a hazardous situation 20 of the vehicle 70 is detected on the basis of at least one situation-dependent driving parameter 22.

The at least one situation-dependent driving parameter 22 can represent at least one of the following hazardous situations for the vehicle 70 that require an adjustment of the base action path 30: malfunction of the driving assistance system 60 of the vehicle 70, recognizing a traffic situation for the vehicle 70 that can no longer be safely managed by the driving assistance system 60 of the vehicle 70.

In a step 104, a defined base action path 30 comprising at least a first action portion 32 is provided, wherein, within the first action portion 32, at least a first vehicle-side action 40 that is suitable to bring the vehicle 70 into a safe state is triggered (step 106) depending on the detected hazardous situation 20.

Optionally, the at least first vehicle-side action 40 may consist of at least one of the following actions for warning at least one person located in the vehicle 70: visual warning, haptic warning, acoustic warning, olfactory warning, an automated intervention in a vehicle behavior of the vehicle 70. In a step 108, the detected hazardous situation 20 for the vehicle 70 is assessed 108.

In a step 110, the base action path 30 is adjusted depending on the assessment of the detected hazardous situation 20 for the vehicle 70.

The adjustment 110 of the base action path 30 may optionally provide for adjusting a degree of execution of the at least first vehicle-side action 40. For example, depending on the identified severity of the hazard, a volume of an output acoustic warning tone could be increased incrementally along the action path. A similar principle can be used with visual, haptic, and olfactory warnings. The triggering of a jerk or movement action in the lateral or longitudinal direction of the vehicle can also vary in strength.

Furthermore, the adjustment 110 of the base action path 30 can also take place if a detected time period for the detected hazardous situation 20 to occur is less than a time period for executing the entire base action path 30.

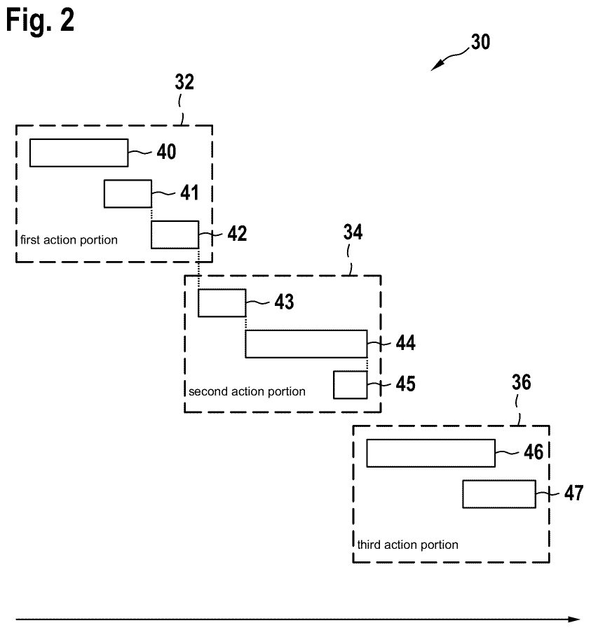

FIG. 2 shows a schematic and exemplary definition of a base action path 30 according to an embodiment of the present invention.

In principle, the base action path 30 can comprise at least a second action portion 34, which follows the first action portion 32, wherein, within the at least second action portion 34, at least a second vehicle-side action 43 is triggered depending on the detected hazardous situation 20.

In the example of FIG. 2, the action path 30 comprises a first action portion 32, a second action portion 34, and a third action portion 36. The horizontal axis shown symbolizes a time curve.

The individual action portions 32, 34, 36 of the action path 30 can each consist of vehicle-side actions 41, 42, 43, 44, 45, 46, 47.

Examples of vehicle-side actions 41, 42, 43, 44, 45, 46, 47 may be:
A visual warning of the driver, e.g., a warning symbol lighting up in the dashboard and/or on the steering wheel. Lighting up can take place permanently or with a luminosity that changes over time. Various colors may also be used.
A haptic warning of the driver, e.g., by a vibration of the steering wheel and/or of the seat and/or of the belt (e.g., by means of an existing belt tensioner tightening and loosening it one or more times).
An acoustic warning of the driver, e.g., by means of warning tones or spoken announcements. The driver may also be addressed by name in order to enhance the effect.
Automated short braking, which results in a noticeable longitudinal jerk.
An automated short steering movement in both directions one after the other, which results in a noticeable lateral jerk, but the vehicle is kept within the lane.
A visual, haptic, or acoustic warning of one or more passengers. A presence of passengers may first be checked for this purpose. If there are no passengers present, an unnecessary time delay up to the next escalation stage can thus be avoided.
An olfactory warning if the vehicle is equipped with such a system. The ventilation system can be used to deliver a fragrance that stimulates the attention of the driver, for example peppermint, but also aromas that trigger negative associations for a short time, for example substances on the basis of hydrogen sulfide (rotten eggs).
Adjusting the interior climate; for example, as a warning, the volume flow of the fan can be increased or the temperature can be adjusted for a short time.
Braking the vehicle to a stop. In this case, the vehicle can additionally be secured, for example by activating the parking brake. Furthermore, a hazard warning system can be activated in order to warn other road users. Braking can take place within the current lane, or an automated lane change can first be carried out in order to park the vehicle, for example in a breakdown lane.
Placing an emergency call, for example via a corresponding service provider, such as the “eCall” service, and/or to stored contacts. With this emergency call, additional information can be transmitted, for example about the location, type and time of the accident, as well as the number of passengers. In particular, the duration of the escalation path up to the time of the accident can be transmitted. This is advantageous because it is thus clear, even before rescue workers arrive, that the driver did not react for a certain time period before the accident.
A warning may also be output by the driving assistance system on a connected smartphone. This has the advantage that such a warning for the driver takes place in a manner that is also customary outside the vehicle, for example a vibration in the pants pocket. In addition, the driver being distracted is in many cases due to the smartphone, i.e., the attention of the driver is already directed to the smartphone. Warning the driver in this way is therefore particularly advantageous. This increases the likelihood of getting the attention of the driver back to the driving task.

An action path 30 that is divided in this way into individual action portions 32, 34, 36 can then be adjusted depending on the detected safety-critical situation for the vehicle 70 as follows and as an example:

Adjusting 110 the base action path 30 may provide that the respective action portions 32, 34, 36, and/or the vehicle-side actions 40 to 47 overlap in time. It is therefore not necessary for one vehicle-side action to be completed before the next action is started. This can increase the overall intensity of a warning.

The vehicle-side actions 40, 43 may extend across the respective individual action portions 32, 34, 36.

The respective action portions 32, 34, 36 may differ with respect to a response of the driver assistance system 60 when a driver in the vehicle 70 reacts to the at least one vehicle-side action 40, 43. This is explained below, by way of example, on the basis of the action path 30 of FIG. 2:
For example, if the driver reacts within a first action portion 32, the driving assistance function remains active. This may be sensible, for example, if it has been recognized that the driver has not been looking at the road for a certain period of time, and the escalation path is consequently started. If the driver reacts within the first action portion 32, the function is continued.
However, if the second action portion 34 of the action path 30 is started, the driver is asked to take over manually. If the driver reacts within the second action portion 34, the function is nevertheless deactivated. Since the driver has not reacted in a first action portion 32, there is legitimate doubt with respect to the attention of the driver at that time so that safe operation of a driving assistance function is no longer ensured. Alternatively, the function may be continued at a lower assistance level until the situation has been resolved and driving can continue within the normal function range.
If the driver reacts neither in a first action portion 32 nor in a second action portion 34, the actions of a third action portion 36, for example automated braking of the vehicle 70 to a stop, are carried out even without a driver's reaction.

Returning to the further possibilities of adjusting the base action path 30, further examples should be mentioned:

Furthermore, when adjusting 110 the base action path 30, individual action portions 32, 34, 36 may specifically be excluded from being executed if this is required and sensible to achieve a defined safety state of the vehicle 70.

Furthermore, the adjustment 110 of the base action path 30 may provide for skipping individual vehicle-side actions 40, 43.

Further aspects of the present invention are described in more detail below.

The mentioned action portions 32, 34, 36 of the action path 30 may overlap in time just like the vehicle-side actions themselves. An action may also be performed for so long that it extends in time across a plurality of portions.

Starting from a basic definition of the action path, the action path is now fully executed or modifications are made to the escalation path, depending on the recognized situation.

Recognized situations may include the following:
1. The driving assistance system recognizes that the driver is no longer attentively monitoring the traffic situation, even though the driver should do so. Such a recognition may, for example, take place by means of interior cameras or may be determined because the driver no longer touches the steering wheel with their hands.
2. A problem with the driving assistance system is determined, for example the failure of a steering actuator or of a braking actuator or contamination of a sensor for detecting the environment, so that continued operation of the driving assistance function can no longer take place safely.
3. A traffic situation or a routing that cannot be safely managed by the driving assistance system is recognized.

For example, in the first-mentioned situation 1), there is no need to deviate from the basic definition of an action path, and the action path is fully executed.

However, it may be necessary to act more quickly, in particular in the second and third situations 2) and 3) mentioned. If such a situation is recognized, an adjusted form of the basic definition of the action path may be executed.

For example, the first actions or portions of the action path at the beginning may be skipped. Alternatively, individual actions of the action path may be skipped during execution. Furthermore, alternatively, the strength of one or more actions may be adjusted.

It is particularly advantageous to determine a time span until a safety-critical situation is reached. For example, a dangerous traffic situation such as a construction site can already be ascertained to be in the future. This time span can then be compared to the duration of the action path in the basic definition. If the duration of the action path is too long, the mentioned modifications can be carried out until the duration of the modified action path is less than the calculated time span.

A further advantage of the method according to the present invention is that some components of the action path can be specifically excluded depending on the situation; for example, in the case of a curve, a lateral jerk could explicitly not be allowed, in order not to jeopardize the driving stability and driver take-over.

In the following, a further exemplary scenario for the action path 30 according to FIG. 2 is to be given:

If the driver reacts within the actions of the first action portion 32, the driving assistance function is continued. If the driver reacts within the actions of the second action portion 34, the driving assistance functions hands the vehicle guidance over to the driver. If the driver does not react, the actions in the third action portion 36 are implemented even without the driver's reaction.

The vehicle-side action 40 is, by way of example, a visual warning in the form of a lighting element of the steering wheel. This warning is maintained for a time period of 5 seconds. Even before this time span has elapsed, action 41 is started, in which a warning tone is played via the speakers within the vehicle for 2 seconds. Action 42 includes a vibration of the driver seat for 2 seconds.

In the second action portion 34, an acoustically spoken request to take over the vehicle guidance now takes place in action 43, followed by action 44, which comprises a warning tone with increased volume in comparison to action 41.

Even before the action 44 has completed, action 45 is started, which comprises a warning jerk in the longitudinal direction.

In the third action portion 36, automatic braking to a stop is now carried out in action 46, and an emergency call is placed by action 47 even before action 46 is completed.

If lack of attention of the driver of the vehicle 70 is now determined, the entire action path 30 is executed. Alternatively, however, if a safety-critical situation for the vehicle 70 is determined, for which the duration for executing the action path is too high, then individual actions or entire portions are removed from the action path, or the action path starts with an action that starts after the action 40, or the action path ends with an action that ends before the action 47.

The adjustment of the action path 30 may also occur if said action path has already been started. For example, if, due to lack of attention of the driver, the action path 30 was initially started such that it would actually be executed fully, and an additional event now occurs, for example another vehicle merges narrowly, the mentioned modifications can be made to the running action path, for example the actions 43 and 44 may be skipped.

An adjustment to the action path may, for example, be carried out due to the following events:
lack of attention/fatigue of the driver
health problems of the driver
change in the surface condition of the road (e.g., asphalt, gravel, potholes, dirt, change in coefficient of friction)
change in weather conditions and/or visibility conditions (e.g., rain, fog, frost, position of the sun, visibility range)
change in the design and lay-out of the road and/or type of the road (construction site, curvature of the road, width of the road, change in road markings or roadway separators, slope; highway, country road, city street)
change in legal requirements (e.g., maximum speed, prohibition of use of certain automated driving functions)
objects on the road (e.g., lost cargo, people, bicycles, animals)
actions by other road users (e.g., braking, merging, erratic behavior)
traffic situations (e.g., traffic jam, traffic density)
technical limitations of the vehicle (e.g., failure/limitation of (backup) actuators such as brake, steering, power train; failure/limitation/soiling of environmental sensors, e.g., radar, cameras, ultrasonic sensors, lidar; failure/limitation of reference sensors, e.g., acceleration sensors, rotation rate sensors, wheel speed sensors; change in tire pressure; failure/limitation of windshield wipers)
the vehicle leaving a spatial area intended for operation of the automated function

What is claimed is:

1. A method for improving safety of a driving assistance system of a vehicle, the method comprising the following steps:
detecting a hazardous situation of the vehicle based on at least one situation-dependent driving parameter;
providing a defined base action path including at least a first action portion, wherein, within the first action portion, at least a first vehicle-side action that is suitable to bring the vehicle into a safe state is triggered depending on the detected hazardous situation;
assessing the detected hazardous situation for the vehicle; and
adjusting the base action path depending on the assessment of the detected hazardous situation for the vehicle.

2. The method according to claim 1, wherein the at least first vehicle-side action includes at least one of the following actions for warning at least one person located in the vehicle: visual warning, haptic warning, acoustic warning, olfactory warning, an automated intervention in a vehicle behavior of the vehicle.

3. The method according to claim 1, wherein the adjustment of the base action path provides for adjusting a degree of execution of the at least first vehicle-side action.

4. The method according to claim 1, wherein the adjustment of the base action path takes place when a detected time period for the detected hazardous situation to occur is less than a time period for executing the entire base action path.

5. The method according to claim 1, wherein the base action path includes at least a second action portion, which follows the first action portion, wherein, within the at least second action portion, at least a second vehicle-side action is triggered depending on the detected hazardous situation.

6. The method according to claim 5, wherein the adjustment of the base action path provides that the first and second action portions and/or the first and second vehicle-side actions overlap in time.

7. The method according to claim 5, wherein the first and second vehicle-side actions extend across the respective first and second action portions.

8. The method according to claim 5, wherein the first and second action portions differ with respect to a response of the driver assistance system when a driver in the vehicle reacts to the at least one first and second vehicle-side action.

9. The method according to claim 5, wherein, when adjusting the base action path, individual action portions are specifically excluded from being executed when the exclusion is required to achieve a defined safety state of the vehicle.

10. The method according to claim 5, wherein the adjustment of the base action path provides for skipping individual vehicle-side actions.

11. The method according to claim 1, wherein the at least one situation-dependent driving parameter represents at least one of the following hazardous situations for the vehicle that require an adjustment of the base action path: malfunction of the driving assistance system of the vehicle, recognizing a traffic situation for the vehicle that can no longer be safely managed by the driving assistance system of the vehicle.

12. The method according to claim 1, wherein the vehicle is an at least partially autonomously driving vehicle.

13. A non-transitory machine-readable data carrier on which is stored a computer program including machine-readable instructions for improving safety of a driving assistance system of a vehicle, the instructions, when executed by one or more computers and/or compute instances, causing the one or more computers and/or compute instances to perform the following steps:
detecting a hazardous situation of the vehicle based on at least one situation-dependent driving parameter;
providing a defined base action path including at least a first action portion, wherein, within the first action portion, at least a first vehicle-side action that is suitable to bring the vehicle into a safe state is triggered depending on the detected hazardous situation;
assessing the detected hazardous situation for the vehicle; and
adjusting the base action path depending on the assessment of the detected hazardous situation for the vehicle.

14. One or more computers and/or compute instances including a non-transitory machine-readable data carrier on which is stored a computer program including machine-readable instructions for improving safety of a driving assistance system of a vehicle, the instructions, when executed by the one or more computers and/or compute instances, causing the one or more computers and/or compute instances to perform the following steps:
detecting a hazardous situation of the vehicle based on at least one situation-dependent driving parameter;
providing a defined base action path including at least a first action portion, wherein, within the first action portion, at least a first vehicle-side action that is suitable to bring the vehicle into a safe state is triggered depending on the detected hazardous situation;
assessing the detected hazardous situation for the vehicle; and
adjusting the base action path depending on the assessment of the detected hazardous situation for the vehicle.
